(19) United States
(12) Patent Application Publication
(10) Pub. No.: US 2020/0146088 A1
(43) Pub. Date: May 7, 2020

(54) SECURE IV RECOVERY IN BLUETOOTH SIG MESH NETWORKS

(71) Applicant: QUALCOMM Incorporated, San Diego, CA (US)

(72) Inventors: Chirag Manojkumar KHARVAR, Bangalore (IN); Sourabh JANA, Bangalore (IN); Ravi Kiran BAMIDI, Bangalore (IN)

(21) Appl. No.: 16/183,716

(22) Filed: Nov. 7, 2018

(51) Int. Cl. H04W 76/19; H04W 76/14; H04L 9/12; H04L 29/06

(52) U.S. Cl. CPC H04W 76/19; H04W 76/14; H04W 84/18; H04L 63/0428; H04L 9/12

(57) ABSTRACT

Systems and methods for initialization vector (IV) index recovery for a Bluetooth special interest group (SIG) mesh network include a receiving device in a first node of the mesh network, wherein the receiving device retrieves, from a secure network beacon (SNB), a retrieved IV index. If the retrieved IV index is greater than a current IV index of the receiving device by at least a value of two, the receiving device enters a recovery mode for recovering a correct IV index. In the recovery mode, the receiving device may receive the correct IV index from a Bluetooth device, if available, over a secure link, or from a trusted device in a second node of the mesh network. The mesh network may also include a monitoring device to provide the correct IV index to the receiving device.

### FIELD OF DISCLOSURE

Disclosed aspects are directed to security measures in mesh networks. More specifically, exemplary aspects are directed to secure recovery of initialization vector (IV) in Bluetooth Special Interest Group (Bluetooth SIG) mesh networks.

### BACKGROUND

Wireless communication networks may include Bluetooth mesh networks (hereinafter, more generally, mesh networks). Specifically, the Bluetooth Special Interest Group (Bluetooth SIG) mesh network provides the capability for many-to-many (m:m) device communications and is optimized for creating large-scale device networks. The Bluetooth SIG mesh network is suited for example, in applications such as building automation, sensor networks and other internet of things (IoT) solutions wherein tens, hundreds, or thousands of devices need to reliably and securely communicate with one another.

The Bluetooth SIG mesh network may utilize known packet formats, such as Bluetooth low energy (BLE) advertisements, for packets being exchanged in the Bluetooth mesh networks. Utilizing such known packet formats enable a receiving device to identify or sniff out the packets to determine if the packets are directed to or intended for the receiving device. Corresponding provisioning procedures used for the Bluetooth SIG mesh network, however, may be vulnerable to attacks like man-in-the-middle, replay attacks, trash-can attacks, etc., as known in the art. For instance, a rogue device may be able to enter a mesh network and compromise other devices in the mesh network by employing one or more of the above attack techniques.

In the case of provisioning a Bluetooth SIG mesh network, an initialization vector (IV) index is used as an entropy for nonce generation. The nonce is used in the security procedures and needs to be unique for all the packets transmitted on the network throughout the network's lifetime. Because of this, a periodic update of the IV index is required. In this regard, an IV update procedure may be used wherein the IV index is to be updated if there is a possibility that a sequence number may wrap around (it is noted that in conventional implementations, the Sequence Number is a 24-bit number, which may have a high chance of wrapping around once all possible combinations using the 24-bits to represent the Sequence Number have been exhausted). In the event that a device of the mesh network is out of range of the mesh network for a sufficiently long period of time, there is a high likelihood that the IV index of the mesh network has changed during the device's absence from the mesh network. In an effort to account for this, the mesh networks include an IV index recovery procedure in their specification (e.g., in the Bluetooth specification). This recovery procedure allows a device or node to recover the IV index, if it has been out of range of the mesh network for a long period of time during which the IV index may have changed.

The IV index recovery procedure mentioned above may be used in situations wherein the device or node has been out of range for a period of time during which the device may have missed one or more IV update procedures. In such cases, upon return to the mesh network, the device may monitor or listen for a secure network beacon to be transmitted on the mesh network, wherein the secure network beacon may include a network identification (ID) of the mesh network and a current IV index of the mesh network. Upon receiving and authenticating the secure network beacon, the device may reset its current IV index to correspond to the value that was received from the secure network beacon. Subsequently, the device may use the updated IV index in its future communications in the mesh network

With the above description of the IV index recovery procedure in mind, it will be appreciated that a rogue device or node in the mesh network may wait for a victim device to come alive in the mesh network (e.g., enter the mesh network for the first time or after a period of absence) and send the victim device a secure network beacon with the correct network ID but an incorrect IV index, while using the same network key as the victim device. Thus, the rogue device may cause an unauthorized change in the IV index which leads to an incorrect IV index. In this case, if the victim device receives and accepts the incorrect IV index supplied by the rogue device, then the victim device will be compromised and unable to communicate in the mesh network due to being in possession of the incorrect IV index. It is recognized herein that an incorrect IV index, as mentioned above, may either be a higher value (but still a valid value) than the correct or current IV index of the mesh network or a lower value than the current IV index of the mesh network, but in any event, the incorrect IV index would nevertheless be of a higher value than the victim device's last known IV index (before the victim device may have gone offline from the mesh network). Accordingly, the victim device, once compromised in this manner, will become non-functional in the mesh network.

As such it will be recognized that since having a correct IV index is important for being able to communicate in the mesh network, there is a need to validate the value of the IV index being received at any time by devices in the mesh network. Current Bluetooth mesh specifications are limited in the authentication procedures with respect to the IV index received from a secure network beacon. Significantly, the current specifications do not prevent a rouge device from replaying an older secure network beacon or creating a new secure network beacon with a high IV index for the purposes of attacking devices of the mesh network in the above-described manner.

In addition to the IV index, the network key is another important element for communication in the mesh network. The current Bluetooth mesh network specifications do not include mechanisms for a device to recover the network key. Thus, a device which has been out of the network for a long period may also miss a network key refresh procedure, if such a network key refresh had occurred during the absence of the device from the mesh network. In this scenario, the device will not be able to recover the IV index information either, as the network key which is being used to get the IV index has also changed and is no longer valid.

Accordingly, there is a need for mechanisms for devices of a mesh network to recover the network key as well as the IV index correctly without being susceptible to attacks from rogue devices as discussed above.

### SUMMARY

Exemplary aspects of the invention are directed to systems and methods for initialization vector (IV) index recovery for a Bluetooth special interest group (SIG) mesh network.

For example, an exemplary aspect is directed to a method of initialization vector (IV) index recovery for a mesh network configured as a Bluetooth special interest group (SIG) mesh network, the method performed by a receiving device in a first node of the mesh network. The method comprises retrieving, from a secure network beacon (SNB), a retrieved IV index. If the retrieved IV index is greater than a current IV index of the receiving device by at least a value of two, the method further comprises entering a recovery mode for recovering a correct IV index.

Another exemplary aspect is directed to an apparatus configured for recovery of an initialization vector (IV) index in a mesh network configured as a Bluetooth special interest group (SIG) mesh network, the apparatus comprising a receiving device in a first node of the mesh network. The receiving device is configured to retrieve, from a secure network beacon (SNB), a retrieved IV index, and if the retrieved IV index is greater than a current IV index of the receiving device by at least a value of two, enter a recovery mode to recover a correct IV index.

Yet another exemplary aspect is directed to an apparatus configured for recovery of an initialization vector (IV) index in a mesh network configured as a Bluetooth special interest group (SIG) mesh network, the apparatus comprising means for retrieving an IV index from a secure network beacon, the means for retrieving being at a first node of the mesh network, and means for entering a recovery mode to recover a correct IV index, if the retrieved IV index is greater than a current IV index by at least a value of two, at the first node.

Yet another exemplary aspect is directed to a non-transitory computer-readable storage medium comprising code, which, when executed by a processor in a receiving device, causes the processor to perform operations for initialization vector (IV) index recovery for a mesh network configured as a Bluetooth special interest group (SIG) mesh network, the receiving being at a first node of the mesh network. The non-transitory computer-readable storage medium comprises code for retrieving, from a secure network beacon (SNB), a retrieved IV index, and code for entering a recovery mode for recovering a correct IV index if the retrieved IV index is greater than a current IV index of the receiving device, by at least a value of two.

### BRIEF DESCRIPTION OF THE DRAWINGS

The accompanying drawings are presented to aid in the description of aspects of the invention and are provided solely for illustration of the aspects and not limitation thereof.

FIG. 1A illustrates a mesh network according to this disclosure.

FIG. 1B illustrates the configuration of one or more devices at nodes of the mesh network of FIG. 1A.

FIG. 2 illustrates a method of IV index recovery from a safe device, according to aspects of this disclosure.

FIGS. 3A-B illustrate example formats for sending requests and receiving responses from safe devices for IV index recovery, according to aspects of this disclosure.

FIG. 4 illustrates an exemplary method of recovering an IV index from a trusted Bluetooth device, according to aspects of this disclosure.

FIG. 5 illustrates a method of index validation/recovery for a Bluetooth special interest group (SIG) mesh network.

### DETAILED DESCRIPTION

Aspects of the invention are disclosed in the following description and related drawings directed to specific aspects of the invention. Alternate aspects may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any aspect described herein as “exemplary” is not necessarily to be construed as preferred or advantageous over other aspects. Likewise, the term “aspects of the invention” does not require that all aspects of the invention include the discussed feature, advantage or mode of operation.

The terminology used herein is for the purpose of describing particular aspects only and is not intended to be limiting of aspects of the invention. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer-readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the aspects described herein, the corresponding form of any such aspects may be described herein as, for example, “logic configured to” perform the described action.

Exemplary aspects of this disclosure are directed to solutions for the above-described security gaps in conventional mesh networks. Specifically, disclosed aspects involve authentication of the IV index received by a device in a mesh network. In this regard, some aspects are directed to validation of an IV index by a receiving device (also interchangeably referred to as a receiving node) in an exemplary mesh network such as a Bluetooth SIG mesh network, wherein the receiving device is itself configured to at least partially validate the IV index. Some aspects are also directed to receiving help from a trusted source for the purposes of IV index validation by a receiving device, wherein the trusted source is configured to determine the correct IV index and provide it to the receiving device. These and other aspects will be discussed in detail in the following sections.

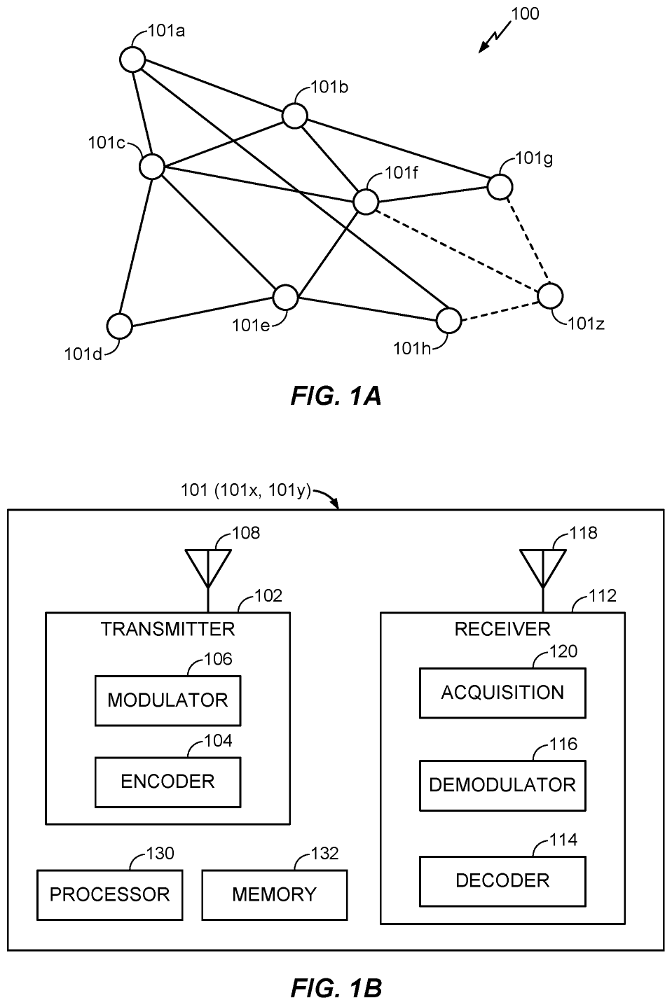

With reference now to FIGS. 1A-B, a simplified schematic diagram of an exemplary mesh network 100 is illustrated in FIG. 1A. Mesh network 100 may be configured as a Bluetooth SIG mesh network in exemplary aspects, and may include several nodes of which nodes 101a-z have been exemplarily shown. Although some solid lines and some dashed lines have been illustrated to indicate possible communication paths between some of the nodes 101a-z, it will be understood that any other communication path supported by relevant standards/specifications may be supported by mesh network 100.

FIG. 1B shows an example configuration of devices which may be located at corresponding nodes 101a-z of mesh network 100, which may be wireless communication devices, and generally designated by the reference numeral 101. In this disclosure, the terms “device” and “node” may be used interchangeably when referring to a device at a particular node. As such, device 101 may support communication of Bluetooth or BLE signals, and as such, include transmitter 102 and receiver 112, whose functionalities may be merged without loss of generality. Exhaustive details of transmitter 102 and receiver 112 have been omitted for the purposes of this discussion, as skilled persons will recognize detailed configurations of these devices. As shown, transmitter 102 includes encoder 104 configured to encode information to be transmitted into a protocol-specific packet format. Modulator 106 is configured to modulate the transmitted bits to corresponding symbols, which are used to modulate a carrier at the carrier frequency of communication paths in mesh network 100, and antenna 108 is configured to transmit wireless signals comprising the modulated carrier on the communication paths. On the receiving end, receiver 112 may comprise antenna 118 configured to receive the wireless signals from the communication paths of mesh network 100. Acquisition block 120 may include functionality for detecting whether the wireless signals received are intended for device 101, e.g., based on acquisition thresholds adapted to signal strength of the wireless signals received on the communication paths. Symbols of the wanted signals are demodulated in demodulator 116, and decoded in decoder 114 in order to retrieve the received information. Also illustrated are processor 130 and memory 132 in device 101, which may be configured to respectively perform the below computations and store information in exemplary aspects.

In a first exemplary aspect, device 101x, which may be located at one of nodes 101a-z and configured according to device 101 of FIG. 1B, may be a receiving device. Device 101x may be configured to validate an IV index received by device 101x. A real-time clock may be provided to stay powered on in device 101x, to enable device 101x to determine timestamps related to the following events. Device 101x may determine and store (e.g., in memory 132), a first timestamp T1, corresponding to the time instance that the IV index was last updated in device 101x. At any point in time, such as after coming alive in mesh network 100 (including after returning to mesh network 100 after a period of absence) device 101x may capture and retrieve information from a secure network beacon (SNB) that device 101x first observes on a communication path of mesh network 100, after coming alive/returning to the network, to validate the IV index.

While other techniques will be discussed below, as an initial check, device 101x may evaluate whether the IV index retrieved from the SNB is likely to be correct, or has been compromised in any manner. For this, device 101x may check if the retrieved IV index is unexpectedly larger than the current IV index which device 101x knows (e.g., is stored in memory 132 of device 101x). If the retrieved IV index is greater than the current IV index of device 101x by a value which is greater than or equal to two, then it may be determined that the IV index has been modified in an unauthorized manner Device 101x may then enter a recovery mode to recover the correct IV index. Various recovery processes will be described in the following sections.

In one aspect, the information retrieved by device 101x from the SNB may include a second timestamp T2, corresponding to the time instance at which the SNB was received by device 101x. From the above timestamps, device 101x can determine a time difference between the current time stamp T2 and the last time stamp T1 associated with the current IV index of device 101x, and compare the time difference to an expected range. Device 101x may calculate the expected IV index range as follows.

Assuming a 96 hour normalization period, the expected IV index range may be represented by the following expression [((T2−T1)/96 HR)+1, (((T2−T1)/96 HR)+1)+FIXED_THRESHOLD]. The FIXED_THRESHOLD may be predetermined constant based on knowledge of the operating characteristics of mesh network 100.

In some aspects, for the purposes of recovering the IV index, device 101x may also scan for more SNBs before accepting an IV index derived from the SNB that device 101x first encounters after coming alive. Various mechanisms may be utilized by device 101x for choosing the correct IV index or the SNB from which to derive the current IV index. In one example, device 101x may choose the most popular IV index from the IV indexes supplied by a plurality of SNBs. In another example, device 101x may trust one or more devices at other nodes 101a-z of mesh network 100 as legitimate, authentic, or trusted devices, wherein such designations of legitimacy/authenticity/trust may be supplied by user configuration or determined by device 101x. Correspondingly, SNBs from the trusted devices may be weighted more heavily when determining the most popular IV index from a plurality of SNBs as mentioned above. Aspects of determining the most popular IV index from a plurality of SNBs may also be referred to as voting mechanisms herein.

In an exemplary aspect, a trusted source at one of nodes 101a-z may be referred to as a monitoring node and device 101y may be designated as a monitoring device. Device 101y may also be configured according to device 101 shown in FIG. 1B. Device 101y may be configured to continuously monitor mesh network 100 and provisioned with relevant information regarding mesh network 100 to assist with such monitoring. Among the relevant information that may be provided or stored in device 101y (e.g., in respective memory 132 of device 101y) the following may be included: a device key, a network key of each device in mesh network 100, and the current IV index, and other state information of mesh network 100.

Based on at least the above relevant information, monitoring device 101y may be configured to monitor or “sniff” all the packets transmitted on mesh network 100 and detect any misbehavior or abnormalities based on this monitoring. Monitoring device 101y may be designated as a trusted source/device by the provisioner of mesh network 100. Monitoring device 101y may be queried for information, e.g., by receiving device 101x, to enable secure recovery of the IV index in one of at least the following two methods.

In a first method of IV index recovery, information from monitoring device 101y may be retrieved by the use of a custom message by receiving device 101x, wherein the custom message may be encrypted with a device key of receiving device 101x. The custom message may be used to indicate to monitoring device 101y, that receiving device 101x desires information for IV index recovery. Monitoring device 101y, upon receipt of the custom message, may provide a response to receiving device 101x, the response comprising the correct/current IV index. The response may further comprise the network key to account for the possibility that the network key may have also changed while receiving device 101x was out of mesh network 100. It is noted that in this first method, only a trusted device such as monitoring device 101y may be able to provide the response as above, since it involves the direct usage of the device key of receiving device 101x, which is sensitive information not to be shared with non-trusted devices.

If receiving device 101x had been out of mesh network 100 for a relatively longer period before returning to mesh network 100, receiving device 101x can request the current IV index from monitoring device 101y using a predefined message. The predefined message may exclude or not utilize the device key of receiving device 101x. Monitoring device 101y will have the last IV index used by receiving device 101x and can decode/authenticate the message sent by receiving device 101x.

In some aspects, monitoring device 101y may be configured to detect a potential rogue device by itself (i.e., without necessarily doing so in response to a request from receiving device 101x for the current IV index) and provide an indication for a user/supervisor to remove the rogue device. In such aspects, monitoring device 101y may be configured to identify one or more victim devices which may have been attacked or compromised by rogue devices and can send the victim devices individual custom messages to update their IV indexes to the correct values.

It is also noted that if a key refresh procedure had taken place while the receiving device 101x was out of mesh network 100, monitoring device 101y may also be configured to send the network key information with a flag value indicating the change in the network key in the same custom message used for providing the current IV index.

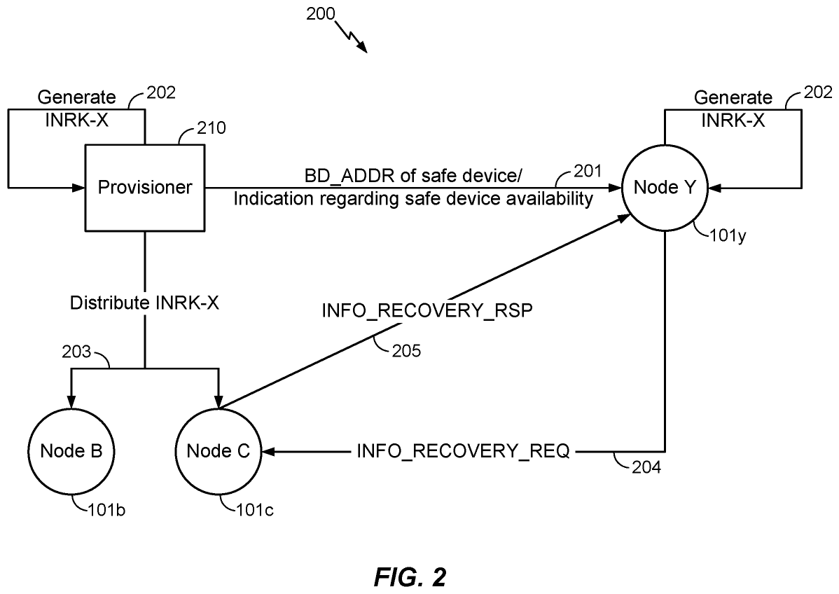

In a second method of IV index recovery, monitoring devices such as monitoring device 101y and/or any other trusted devices in mesh network 100 will be referred as a “safe device”. If the safe device is monitoring device 101y, the safe device would have the device key of devices in all nodes 101a-z and as such, the safe device can generate a new key called IV/NetKey Recovery Key (INRK). In case the safe device is a trusted device other than a monitoring device, and the safe device does not have the device keys of devices at all nodes 101a-z, then a method as described with reference to FIG. 2 below may be used by the safe device to get INRKs of the neighboring devices.

With reference now to FIG. 2, method 200 for IV index recovery will be discussed. Method 200 generally includes steps 201-205, shown in conjunction with corresponding devices and nodes, e.g., of a mesh network such as mesh network 100, configured to perform steps 201-205 of method 200. Provisioner 210 may be a supervisor of mesh network 100. In step 201, provisioner 210 may designate and send indications thereof to devices in one or more nodes that these devices are trusted devices or, for example, a monitoring device 101y at node Y for a particular receiving device 101x. In this step 201, provisioner 210 may also send the device a so called BD_ADDR, which indicates the address of a safe device or the availability thereof. Upon receipt, the device at node Y, e.g., monitoring device 101y, may store the message received in step 201.

In step 202, provisioner 210 may generate the INRK for the trusted devices. In step 203, provisioner 210 may distribute these INRKs to the trusted devices such as devices 101b, 101c, respectively at node B and node C. It is noted, however, that provisioner 210 need not send the INRK to monitoring device 101y at node Y, since monitoring device 101y already has the device keys of all the devices in mesh network 100 (hence, step 202 may also be performed by monitoring device 101y at node Y, as shown).

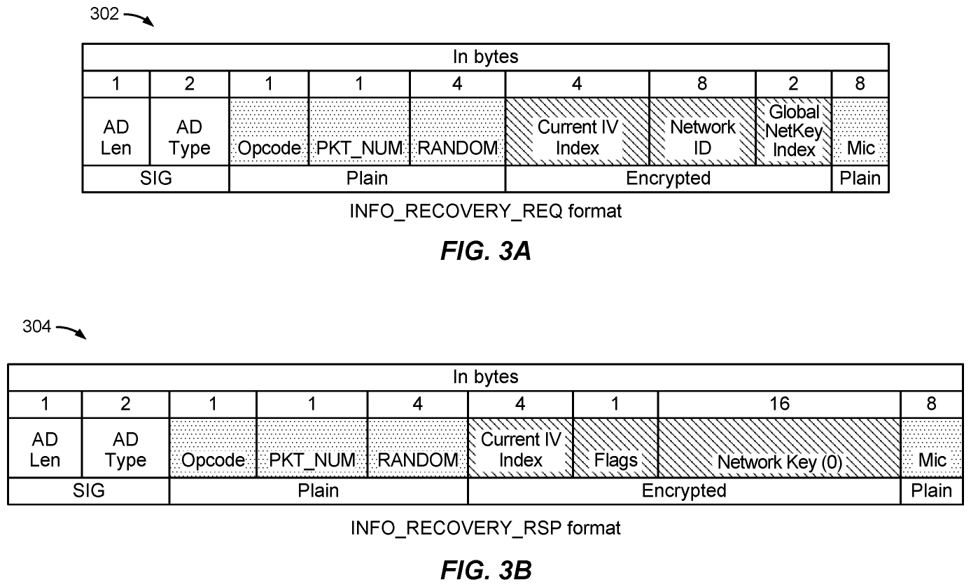

In step 204, monitoring device 101y at node Y may send a request to recover IV index information. In an aspect, this request is shown as INFO_RECOVERY_REQ request, which may be sent by setting an operation code (opcode) for a request for the IV index and a RANDOM Value associated with the request. An example format for the INFO_RECOVERY_REQ request will be discussed with reference to FIG. 3A. Monitoring device 101y may also provide information such as the current IV index, current network ID, global NetKey index etc., in the request sent in step 204, wherein the network ID and the global NetKey index may be used to check whether receiving device 101x would require a key refresh or not.

In some aspects, following the transmission of the request in step 204, monitoring device 101y may start a timer for expecting a response. If the timer runs out before a response is received, then monitoring device 101y may generate a new request with a new RANDOM value. The timeout value for the timer may be chosen such that it allows for sufficient time for devices 101b, 101c in neighbor nodes B, C, respectively, to send a response. Furthermore, the request from monitoring device 101y may be encrypted using the INRK-X, which means that only the devices having INRK-X (i.e., safe devices 101b, 101c) will be able to understand the request and generate a response.

In step 205, upon receipt of the request from monitoring device 101y, the one or more safe devices 101b, 101c may generate a response using the message, INFO_RECOVERY_RSP. An example format for the INFO_RECOVERY_RSP request will be discussed with reference to FIG. 3B. This message will include the information requested, such as the current IV index, flags, and optionally, the network key of mesh network 100. As this message is encrypted using INRK-X of the node, only the safe devices 101b, 101c in nodes B, C, for example, will be able to understand the message.

The number of responses sent by the safe devices 101b, 101c, etc., may be configurable and can be based, for example, on time duration, a predetermined number, etc. The contents of example recovery messages are explained in further detail below.

Referring now to FIGS. 3A-B, example formats for INFO_RECOVERY_REQ 302 of step 204, FIG. 2, and INFO_RECOVERY_RSP 304 of step 205, FIG. 2, will be discussed. In FIG. 3A, INFO_RECOVERY_REQ 302 is shown to comprise the following fields, whose definitions are provided in tabular format in Table 1 below. INFO_RECOVERY_REQ 302 may be used by receiving device 101x for IV index recovery and recovery of other information from one or more safe devices, as discussed above.

TABLE 1
INFO_RECOVERY_REQ fields definitions

| Field Name | Bytes | Notes |
|---|---|---|
| Opcode | 1 | This indicates the type of the command |
| | | which is passed in the message i.e. Request |
| | | or Reply |
| PKT_NUM | 1 | In case of segmented packet, it represents |
| | | segment number, 0 otherwise. |
| RANDOM | 4 | Random value associated with each request. |
| | | Used for calculating nonce. Introduced to |
| | | counter replay attacks. |
| Current IV | 4 | Current IV index of the device in recovery |
| Index | | |
| Network ID | 8 | Current Network ID used by the device in |
| | | recovery. This in conjunction with Net Id is |
| | | used for checking whether the key used by |
| | | the device is correct or not. |
| Global | 2 | 12-bit Global NetKey Index |
| NetKey Index | | |
| MIC | 8 | Message Integrity Check for the beacon |

In exemplary aspects, the request message INFO_RECOVERY_REQ 302 may be encrypted as follows:

### PAYLOAD=(Current IV Index∥Network ID∥Global NetKey Index)

### NONCE=(Opcode-REQ∥PKT_NUM∥RANDOM)

### (Encrypted Request Message, MIC)=AES-CCM (INRK-X, NONCE, PAYLOAD)

Similarly, with reference to FIG. 3B, INFO_RECOVERY_RSP 304 is shown to comprise the following fields, whose definitions are provided in tabular format in Table 2 below. INFO_RECOVERY_RSP 304 may be used by one or more safe nodes to respond to INFO for IV index recovery and recovery of other information from one or more safe devices, as discussed above.

TABLE 2
INFO_RECOVERY_RSP fields definitions

| Field Name | Bytes | Notes |
|---|---|---|
| Opcode | 1 | This indicates the type of the command |
| | | which is passed in the beacon i.e. Request or |
| | | Reply |
| PKT_NUM | 1 | In case of segmented packet, it represents |
| | | segment number, 0 otherwise. |
| RANDOM | 4 | Random value associated with each reply. |
| | | This value will be different from the request |
| | | but will be associated with each request. |
| | | Used for calculating nonce. Introduced to |
| | | counter replay attacks. |
| Current IV | 4 | Current IV index of the Network |
| Index | | |
| Flags | 1 | This contains IV and/or Key refresh flags |
| Network Key | 8 | Current Network key which is being used in |
| (Optional) | | the network. This is given in case when the |
| | | device in recovery have missed key refresh |
| | | while it was out of network. |
| MIC | 8 | Message Integrity Check for the beacon |

In exemplary aspects, the response message INFO_RECOVERY_RSP 304 may be encrypted as follows:

### PAYLOAD=(Current IV Index∥Flags∥Network Key)

### NONCE=((Plain Part of Request Message)|(Opcode-RSP∥PKT_NUM∥RANDOM))

### (Encrypted Response Message, MIC)=AES-CCM (INRK-X, NONCE, PAYLOAD)

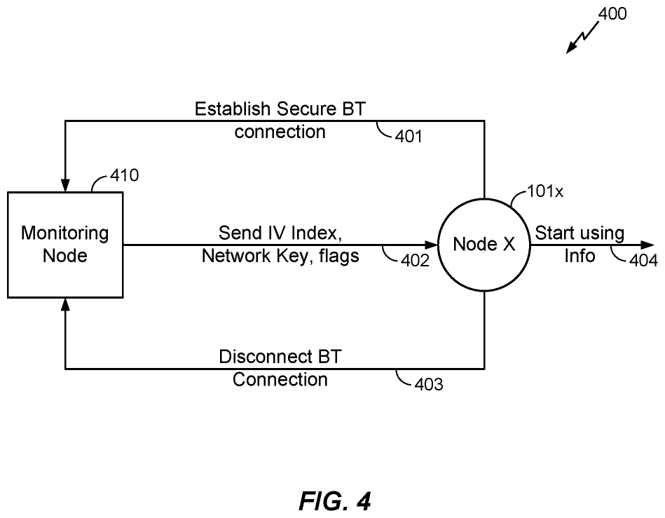

With reference now to FIG. 4, aspects of getting the information for IV index recovery over a secure Bluetooth link (e.g., a Bluetooth pairing or BLE Secure connection) will be discussed with reference to method 400. Device 101x is shown at node X and monitoring node 410 may comprise a device configured to communicate with device 101x over a Bluetooth link which may be separate from one or more communication paths of mesh network 100. Using this separate Bluetooth link the recovery information such as IV index, flags, network key, etc., may be securely exchanged between device 101x and monitoring node 410.

Specifically, at step 401, device 101x may establish the secure Bluetooth connection with monitoring node 410. At step 402, monitoring node 410 may send information including the correct IV index, network key, flags, etc., to device 101x. At step 403, device 101x may disconnect the secure Bluetooth connection, having recovered the IV index, and at step 404, device 101x may start using the recovered IV index and other information for future communications on mesh network 100.

It is also possible to blacklist one or more devices identified as rogue devices according to aspects of this disclosure. One or more of receiving device 101x or monitoring device 101y (generally referred to as a “node device”), may store the Bluetooth Device (BD) address (ADDR) of devices recognized as sending IV index values on mesh network 100 which are much higher than expected/current IV index values. Upon verifying the IV index information and other network information using any one or more of the above-described techniques, the node device may blacklist the nodes at which the devices are transmitting the incorrect IV index values. Apart from the BD address, the node device can also store information such as the angle of arrival values from the blacklisted nodes and can use such information in combination with the BD Address to blacklist the nodes. The node device may be further configured to ignore all future messages coming from the blacklisted nodes.

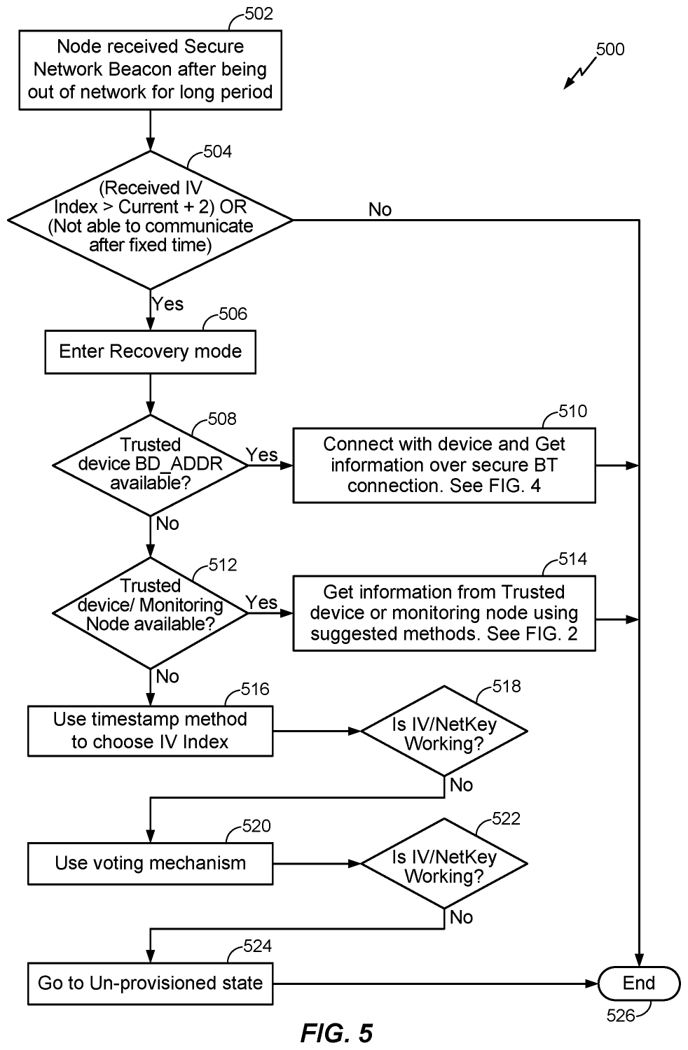

It will be appreciated that exemplary aspects include various methods for performing the processes, functions and/or algorithms disclosed herein. For example, FIG. 5 illustrates a method 500 of IV index recovery (e.g., in mesh network 100 configured as a Bluetooth SIG mesh network).

Block 502 comprises receiving, e.g., by receiving device 101x at a node of mesh network 100, a secure network beacon (SNB) after receiving device 101x has been out of mesh network 100 for a long time. Receiving device 101x may retrieve the IV index from the SNB in Block 502.

In Block 504, receiving device 101x determines whether the IV index retrieved from the SNB is greater than the current IV index stored in receiving device 101x by at least a value of two (2), or if receiving device 101x is unable to communicate on mesh network 100 for greater than a predetermined time using its retrieved IV index. If the determination in Block 504 is in the negative (or “no”), then method 500 ends at Block 526, or otherwise (i.e., “yes”) proceeds to Block 506.

In Block 506, receiving device 101x enters a recovery mode, leading first to Block 508.

In Block 508, if there is a trusted Bluetooth Device (BD_ADDR) available (e.g., according to method 400), then in Block 510, receiving device 101x may connect with the Bluetooth device (e.g., monitoring node 410) and obtain the information for recovering the IV index over a secure Bluetooth link, and proceed to end Block 526. If there is no trusted Bluetooth device available in Block 508, method 500 proceeds to Block 512.

In Block 512, if there is a trusted or monitoring device (e.g., monitoring device 101y or safe devices 101b-c of FIG. 2) available, then receiving device 101x may obtain the information for recovering the IV index from one of the trusted device or monitoring device as in method 200 of FIG. 2, in Block 514, and ends in Block 526. Otherwise, from Block 512, method 500 proceeds to Block 516.

In Block 516, receiving device 101x attempts to recover the IV index using the aforementioned timestamps, and in Block 518, checks whether the IV index or NetKey is working for future communication on mesh network 100. If the determination in Block 518 is negative, then in Block 520, a voting mechanism is used to determine a popular IV index from a plurality of neighboring nodes, to determine once again in Block 522 whether the IV index or NetKey is working for future communication on mesh network 100. If Block 522 also evaluates to a negative, then receiving device 101x goes to an un-provisioned state in Block 524 and the method ends in Block 526.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an aspect of the invention can include a computer-readable media embodying a method for initialization vector (IV) validation/recovery for Bluetooth special interest group (SIG) mesh network. Accordingly, the invention is not limited to illustrated examples and any means for performing the functionality described herein are included in aspects of the invention.

While the foregoing disclosure shows illustrative aspects of the invention, it should be noted that various changes and modifications could be made herein without departing from the scope of the invention as defined by the appended claims. The functions, steps and/or actions of the method claims in accordance with the aspects of the invention described herein need not be performed in any particular order. Furthermore, although elements of the invention may be described or claimed in the singular, the plural is contemplated unless limitation to the singular is explicitly stated.

What is claimed is:

1. A method of initialization vector (IV) index recovery for a mesh network configured as a Bluetooth special interest group (SIG) mesh network, the method performed by a receiving device in a first node of the mesh network, the method comprising:
retrieving, from a secure network beacon (SNB), a retrieved IV index; and
if the retrieved IV index is greater than a current IV index of the receiving device by at least a value of two, entering a recovery mode for recovering a correct IV index.

2. The method of claim 1, further comprising:
in the recovery mode, determining that a trusted Bluetooth device is available;
establishing a secure Bluetooth link with the trusted Bluetooth device; and
receiving information for recovering the correct IV index from the trusted Bluetooth device on the secure Bluetooth link.

3. The method of claim 1, further comprising, in the recovery mode, determining that a trusted device is available at a second node of the mesh network, and recovering the current IV index from the trusted device.

4. The method of claim 3, wherein recovering the current IV index from the trusted device comprises sending a custom message from the receiving device to the trusted device and receiving a response to the custom message from the trusted device, the response comprising the current IV index.

5. The method of claim 4, wherein the custom message is encrypted with a device key of the receiving device.

6. The method of claim 4, wherein the custom message is a predefined message.

7. The method of claim 4, wherein the response further comprises a network key of the mesh network.

8. The method of claim 3, wherein the trusted device is designated by a provisioner of the mesh network.

9. The method of claim 1, further comprising, in the recovery mode,
receiving a current time stamp from the SNB;
determining, a time difference between the current time stamp and a last time stamp associated with the current IV index of the receiving device; and
comparing the time difference to an expected range.

10. The method of claim 1, further comprising determining that the retrieved IV index is incorrect due to unauthorized change in the IV index by a rogue device.

11. The method of claim 10, further comprising blacklisting the rogue device and preventing future communication with the rogue device.

12. The method of claim 1, further comprising, in the recovery mode, polling surrounding nodes of the receiving device for current values of the IV index, and determining the correct IV index to be a most popular IV index from the polling.

13. The method of claim 1, further comprising receiving information from a monitoring device about the correct IV index, wherein the monitoring device determines whether there is an attack on the mesh network.

14. An apparatus configured for recovery of an initialization vector (IV) index in a mesh network configured as a Bluetooth special interest group (SIG) mesh network, the apparatus comprising:
a receiving device in a first node of the mesh network, wherein the receiving device is configured to:
retrieve, from a secure network beacon (SNB), a retrieved IV index; and
if the retrieved IV index is greater than a current IV index of the receiving device by at least a value of two, enter a recovery mode to recover a correct IV index.

15. The apparatus of claim 14, wherein the receiving device is further configured to, in the recovery mode:
determine that a trusted Bluetooth device is available;
establish a secure Bluetooth link with the trusted Bluetooth device; and
receive information for recovering the correct IV index from the trusted Bluetooth device on the secure Bluetooth link.

16. The apparatus of claim 14, wherein the receiving device is further configured to, in the recovery mode, determine that a trusted device is available at a second node of the mesh network, and recover the current IV index from the trusted device.

17. The apparatus of claim 16, wherein the receiving device is configured to send a custom message to the trusted device and receive a response to the custom message from the trusted device, the response comprising the current IV index.

18. The apparatus of claim 17, wherein the custom message is encrypted with a device key of the receiving device.

19. The apparatus of claim 17, wherein the custom message is a predefined message.

20. The apparatus of claim 17, wherein the response further comprises a network key of the mesh network.

21. The apparatus of claim 16, wherein the trusted device is designated by a provisioner of the mesh network.

22. The apparatus of claim 14, wherein the receiving device is further configured to, in the recovery mode:
receive a current time stamp from the SNB;
determine, a time difference between the current time stamp and a last time stamp associated with the current IV index of the receiving device; and
compare the time difference to an expected range.

23. The apparatus of claim 14, wherein the receiving device is configured to determine that the retrieved IV index is incorrect due to unauthorized change in the IV index by a rogue device.

24. The apparatus of claim 23, further wherein the receiving device is configured to cause the rogue device to be blacklisted and prevent future communication with the rogue device.

25. The apparatus of claim 14, wherein the receiving device is further configured to, in the recovery mode, poll surrounding nodes of the receiving device for current values of the IV index, and determine the correct IV index to be a most popular IV index from the poll.

26. The apparatus of claim 14, wherein the receiving device is further configured to receive information from a monitoring device about the correct IV index, wherein the monitoring device is configured to determine whether there is an attack on the mesh network.

27. An apparatus configured for recovery of an initialization vector (IV) index in a mesh network configured as a Bluetooth special interest group (SIG) mesh network, the apparatus comprising:
means for retrieving a retrieved IV index from a secure network beacon (SNB), the means for retrieving being at a first node of the mesh network; and
means for entering a recovery mode to recover a correct IV index if the retrieved IV index is greater than a current IV index at the first node, by at least a value of two.

28. A non-transitory computer-readable storage medium comprising code, which, when executed by a processor in a receiving device, causes the processor to perform operations for initialization vector (IV) index recovery for a mesh network configured as a Bluetooth special interest group (SIG) mesh network, the receiving being at a first node of the mesh network, the non-transitory computer-readable storage medium comprising:
code for retrieving, from a secure network beacon (SNB), a retrieved IV index; and
code for entering a recovery mode for recovering a correct IV index if the retrieved IV index is greater than a current IV index of the receiving device, by at least a value of two.

29. The non-transitory computer-readable storage medium of claim 28, further comprising:
code for determining, in the recovery mode, that a trusted Bluetooth device is available;
code for establishing a secure Bluetooth link with the trusted Bluetooth device; and
code for receiving information for recovering the correct IV index from the trusted Bluetooth device on the secure Bluetooth link.

30. The non-transitory computer-readable storage medium of claim 28, further comprising, in the recovery mode, code determining that a trusted device is available at a second node of the mesh network, and code recovering the current IV index from the trusted device.
